(19) United States
(12) Patent Application Publication
(10) Pub. No.: US 2012/0311593 A1
(43) Pub. Date: Dec. 6, 2012

(54) ASYNCHRONOUS CHECKPOINT ACQUISITION AND RECOVERY FROM THE CHECKPOINT IN PARALLEL COMPUTER CALCULATION IN ITERATION METHOD

(75) Inventors: Tatsuya Ishikawa, Kanagawa-ken (JP); Hiroki Murata, Kanagawa-ken (JP); Yasushi Negishi, Kanagawa-ken (JP)

(73) Assignee: International Business Machines Corporation, Armonk, NY (US)

(21) Appl. No.: 13/572,844

(22) Filed: Aug. 13, 2012

Related U.S. Application Data
(63) Continuation of application No. 13/396,820, filed on Feb. 15, 2012.

(30) Foreign Application Priority Data
Feb. 25, 2011 (JP) 2011-040262

(51) Int. Cl. G06F 9/46

(52) U.S. Cl. 718/102

(57) ABSTRACT

A method and system to acquire checkpoints in making iteration-method computer calculations in parallel and to effectively utilize the acquired data for recovery. At the time of acquiring a checkpoint in parallel calculation that repeats an iteration method, each node independently acquires the checkpoint in parallel with the calculation without stopping the calculation. Thereby, it is possible to perform both of the calculation and the checkpoint acquisition in parallel. In the case where the calculation does not impose an I/O bottleneck, checkpoint acquisition time is overlapped, and execution time is reduced. In this method, checkpoint data including values at different points of time during the acquisition process is acquired. By limiting the use purpose to iteration-method convergence calculations, mixture of the values at the different points of time in the checkpoint data is accepted in the problem that a convergence destination does not depend on an initial value.

### CROSS REFERENCE TO RELATED APPLICATION

This application is a continuation of and claims priority from U.S. application Ser. No. 13/396820 filed on Feb. 15, 2012, which in turn claims priority under 35 U.S.C. 119 from Japanese Application 2011-040262, filed Feb. 25, 2011, the entire contents of both applications are incorporated herein by reference.

### BACKGROUND OF THE INVENTION

1. Field of the Invention

The present invention relates to a technique for acquiring checkpoints in making iteration-method computer calculations in parallel to effectively utilize the acquired data for recovery.

2. Description of Related Art

As the scale of supercomputers increases, the increase in time required for checkpoints is becoming problematic. The acquisition of a checkpoint takes a lot of time. Since a checkpoint of memory is acquired at a particular point of time while rewriting continues, overhead for securing consistency, such as suspension of calculation during the acquisition of the checkpoint, is required.

A first example of a technique currently used is copy-on-write and incremental checkpointing. After write-protecting memory by using copy-on-write in this scheme, a checkpoint is acquired in advance without stopping (interrupting) calculation. The calculation is stopped after acquiring the checkpoint in advance, and an updated part copied by the copy-on-write mechanism during acquisition of the checkpoint is reflected on the checkpoint acquired in advance.

A disadvantage of this scheme is that this approach can be said to be effective only when a small extent of the memory is updated. In the case of applying this approach to LU decomposition calculation, a method of solving Poisson's equation and the like, a large extent of memory is updated during acquisition of a checkpoint. Therefore, stop time for reflecting changes on the checkpoint acquired in advance is required, and the stop time cannot be saved.

A second example of a technique currently used is the use of a nonvolatile medium other than a disk, such as a flash memory, an MRAM or the like. In this scheme, time is reduced by temporarily copying data to a high-speed nonvolatile medium before writing the data to a low-speed medium such as an HDD.

A disadvantage of this scheme is the high additional cost for the nonvolatile memory.

In addition, as for element techniques related to the acquisition of a checkpoint, there are techniques as disclosed in Japanese Patent Laid-Open No. 7-271624 and Japanese Patent Laid-Open No. 9-204318. However, none of these relate to iteration-method calculation.

The object of the present invention is to acquire checkpoints in making iteration-method computer calculations in parallel and to effectively utilize the acquired data for recovery.

### SUMMARY OF THE INVENTION

In order to overcome these deficiencies, the present invention provides a method implemented in a system including a certain node and at least one other node, the method including: starting, by the certain node, computer calculations based on a data group for calculation belonging to a certain discrete time and executing an iteration-method calculation until a result of the calculations are converged within a predetermined range; acquiring, by the certain node, an intermediate calculation group as a checkpoint at a predetermined timing, in parallel with the execution of the iteration-method calculation, without stopping the started computer calculations; storing, by the certain node, the acquired intermediate calculation group as a checkpoint into an external memory; waiting, by the certain node, until it is confirmed that all the above-stated processes are performed in parallel in the other node and have been completed before evolving the certain discrete time to a next discrete time; and referring, by the certain node, in response to the completion being confirmed, to a converged calculation result and starting next computer calculations based on a next data group for calculations belonging to the next discrete time.

According to another aspect, the present invention provides a system including a certain node and at least one other node, wherein: the certain node starts computer calculations based on a data group for calculation belonging to a certain discrete time and executes an iteration-method calculation until a result of the calculation is converged within a predetermined range; the certain node acquires an intermediate calculation group as a checkpoint at a predetermined timing, in parallel with the execution of the iteration-method calculation, without stopping the started computer calculations; the certain node stores the acquired intermediate calculation group as a checkpoint into an external memory; the certain node waits until it is confirmed that all the above-stated processes are performed in parallel in the other node and have been completed before evolving the certain discrete time to a next discrete time; and in response to the completion being confirmed, the certain node refers to a converged calculation result and starts next computer calculations based on a next data group for calculation belonging to the next discrete time.

According to yet another aspect, the present invention provides A node capable of independently making computer calculations, including a CPU, a check system and a memory, the node being linked with at least one other node so as to be communicable with each other, the computer calculations being made in parallel between these multiple nodes while a data group for calculation belonging to some discrete time is evolved from a certain discrete time to a next discrete time, wherein the node: starts computer calculations based on the data group for calculation belonging to the certain discrete time and executes an iteration-method calculation until a result of the calculation is converged within a predetermined range; acquires an intermediate calculation group as a checkpoint at a predetermined timing in parallel with the execution of the iteration-method calculation without stopping the started computer calculation; stores the acquired intermediate calculation group as a checkpoint into an external memory; waits until it is confirmed that all the above-stated processes are performed in parallel in the other node and have been completed before evolving the certain discrete time to the next discrete time; and in response to the completion being confirmed, refers to a converged calculation result and starts next computer calculations based on a next data group for calculation belonging to the next discrete time.

### BRIEF DESCRIPTION OF THE SEVERAL VIEWS OF THE DRAWINGS

FIG. 1 is a diagram showing the configuration of a node to be a basic unit and the configuration of multiple such nodes forming a communication link to which the present invention is applied;

FIG. 2 is a schematic diagram illustrating time evolution in iteration-method calculation and acquisition of a checkpoint;

FIG. 3 is a diagram comparing a conventional approach and an approach of the present invention;

FIG. 4 is a diagram showing a procedure for acquiring a checkpoint;

FIG. 5 is a diagram showing a procedure for recovery from a checkpoint;

FIG. 6 is a graph of cost for reliability which is expected when the approach of the present invention is implemented and which has been theoretically calculated; and

FIG. 7 is a graph showing an example of applying the approach of the present invention to a Poisson's equation.

### DETAILED DESCRIPTION OF THE PREFERRED EMBODIMENTS

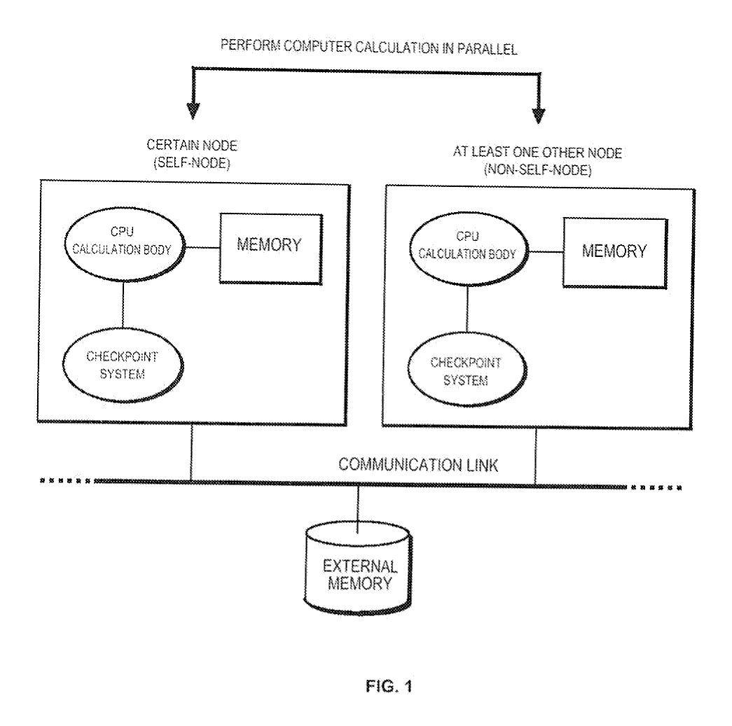

FIG. 1 is a diagram showing configuration of a node to be a basic unit and configuration of multiple such nodes forming a communication link to which the present invention is applied. Though any external memory connection scheme and any kind of memory are possible in various embodiments of the present invention, a nonvolatile memory connected via NAS/SAN or the like, such as a hard disk, is commonly used as an external memory.

Each node includes a CPU (calculation body), a checkpoint system and a memory and can independently make computer calculations. In FIG. 1, there is shown a node (self-node) and at least one other node (non-self-node) among all nodes which make calculations in parallel, and these multiple nodes are linked so that they can communicate with one another.

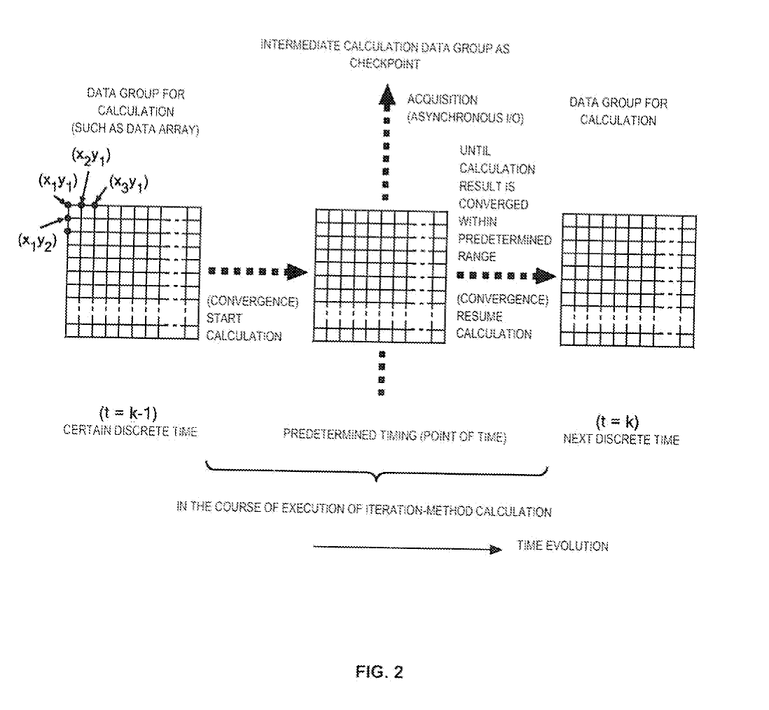

FIG. 2 is a schematic diagram illustrating time evolution in an iteration-method calculation and acquisition of a checkpoint. It is a basis of computer calculation (physical phenomenon simulation or the like) to make the computer calculations in parallel while time-evolving a data group for calculation (such as a data array) belonging to some discrete time from a certain discrete time (t=k−1) to the next discrete time (t=k).

Regarding the data group for calculation, for example, a differential equation expressed by a Poisson's equation is discretized in a form like meshes in a two-dimensional space expressed by x or y as shown in the figure, and a physical variable is given at each of the mesh intersections (x1, y1), (x2, y1), (x3, y1), . . . . In a computer calculation, the amount of memory occupied is reduced by overwriting a new value calculated as the value of a mesh intersection in the process of time evolution. In common programming, an array in a computer program is used as a framework for storing values corresponding to the number of mesh intersections×the number of kinds of physical variables until the next discrete time.

At the certain discrete time (t=k−1), (convergence) calculation is started. The calculation is not advanced to the next discrete time (t=k) until the calculation result is converged within a predetermined range. The name “iteration method” is derived from the fact that the calculation is iteratively repeated until the calculation result is converged. As for the “predetermined range” for use in determining whether the calculation result has been converged or not, one skilled in the art could introduce various kinds of threshold decisions or appropriately change the range according to the condition of convergence. It is known that the condition of convergence also influences the degree of discretization of time t [here, the interval between (k−1) and k].

In the present embodiment, an intermediate calculation data group as a check point is acquired at a predetermined timing (point of time) in the course of execution of the iteration-method calculation. This acquisition is performed by an asynchronous I/O (input/output) operation without stopping/suspending the started computer calculation.

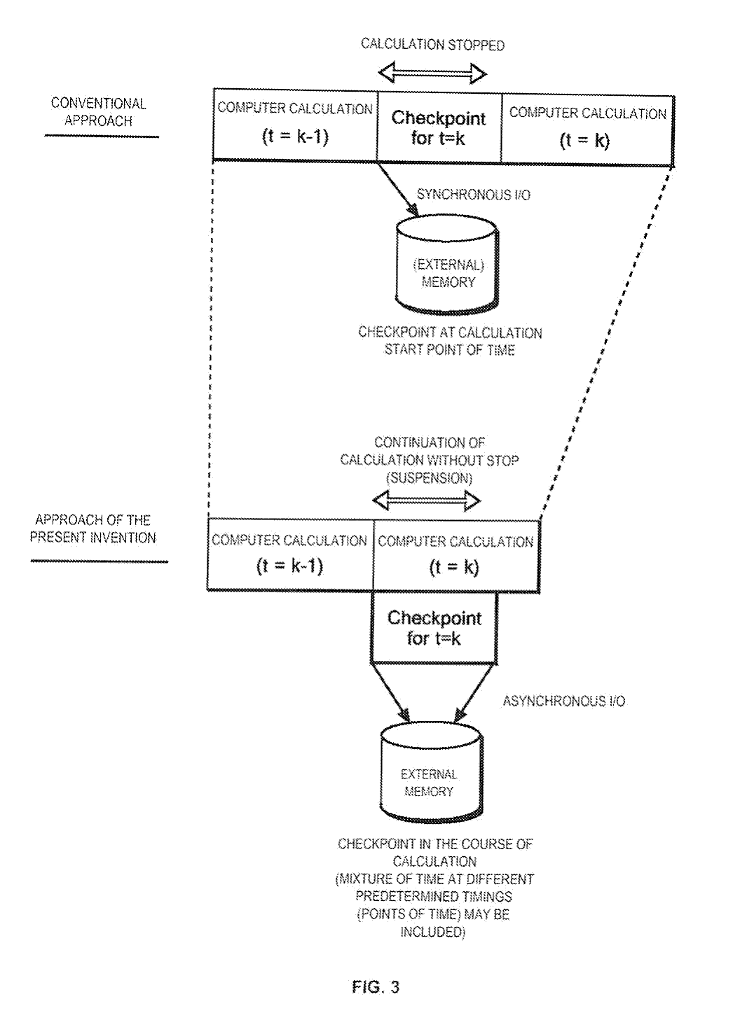

FIG. 3 is a diagram comparing a conventional approach and an approach of the present embodiment. In conventional approaches, a synchronous I/O operation of acquiring a checkpoint at a calculation start point of time has been performed. In the approach of the present invention, a checkpoint in the course of calculation is acquired by an asynchronous I/O operation without stopping/suspending the computer calculation. According to the approach of the present embodiment, it is possible to continue executing the iteration-method calculation, but a mixture of time at different predetermined points of time may be included.

Therefore, it is important for the self-node to store the acquired intermediate calculation data group as a check point in the external memory. This is because the computer calculation is started there in the case of recovery from the checkpoint.

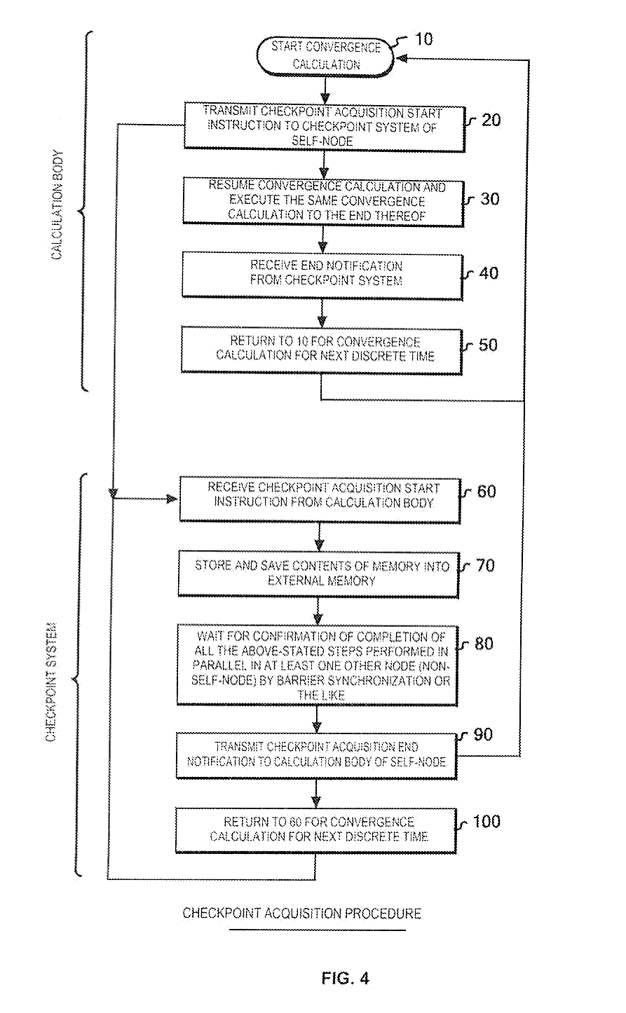

FIG. 4 is a diagram showing a procedure for acquiring a checkpoint. FIG. 4 shows a procedure as an aspect in which the CPU (calculation body) and the checkpoint system shown in FIG. 1 are separated and are in cooperation with each other. However, one skilled in the art could practice the present invention in various other variations, for example, in an embodiment as hardware resources, an embodiment as software resources (such as a computer program) and an embodiment in which hardware resources and software resources are in cooperation with each other.

The calculation body starts convergence calculation at 10. At 20, a checkpoint acquisition instruction is transmitted to the checkpoint system of the self-node (coordination with the checkpoint system). At 30, the convergence calculation is resumed and executed to the end thereof. At 40, an end notification is received from the checkpoint system (coordination with the checkpoint system). At 50, the procedure returns to 10 for convergence calculation for the next discrete time.

At 60, the checkpoint system receives a checkpoint acquisition start instruction from the calculation body. At 70, the contents of the memory are stored in the external memory. At 80, the checkpoint system waits until it is confirmed that all the above-stated steps performed in parallel in all the relevant nodes have been completed, by barrier synchronization between the at least one other node (non-self-node) and the checkpoint system before time-evolving discrete time to the next discrete time.

At 90, the checkpoint system transmits a checkpoint acquisition end notification to the calculation body of the self-node in response to the completion being confirmed, and the notification is received by the calculation body at 40 (coordination with the calculation body). Thereby, at 50, the calculation body of the self-node refers to the converged calculation result and starts a computer calculation based on a data group for calculation belonging to the next discrete time. At 100, the procedure returns to 60 for convergence calculation for the next discrete time. Before time evolution to the next discrete time, it is possible to continuously acquire (or prepare to acquire) a checkpoint at a different timing (point of time).

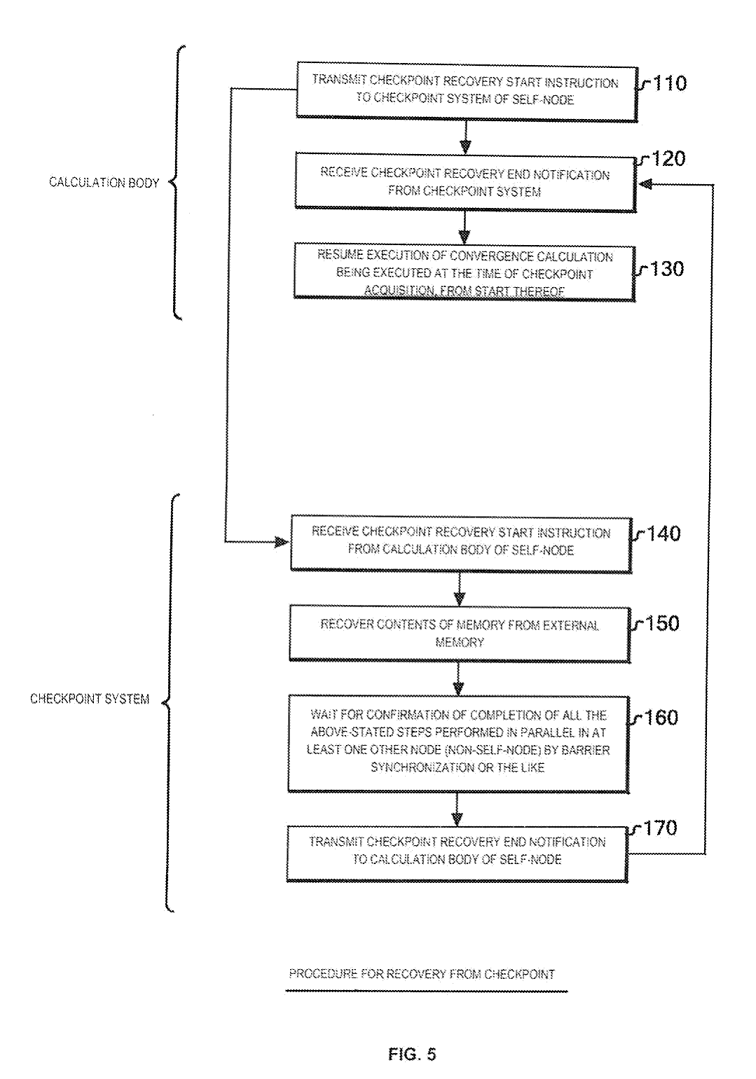

FIG. 5 is a diagram showing a procedure for recovery from a checkpoint. Similar to that of FIG. 4, FIG. 5 shows a procedure as an embodiment in which the CPU (calculation body) and the checkpoint system shown in FIG. 1 are separated and are in cooperation with each other.

At 110, the calculation body transmits a checkpoint recovery start instruction to the checkpoint system of the self-node (coordination with the checkpoint system). At 120, a checkpoint recovery end instruction is received from the checkpoint system (coordination with the checkpoint system). At 130, execution of the convergence calculation being executed at the time of acquiring the checkpoint is resumed from the start thereof.

At 140, the checkpoint system receives a checkpoint recovery start instruction from the calculation body of the self-node (coordination with the calculation body). At 150, the contents of the memory are recovered from the external memory. At 160, the checkpoint system waits until it is confirmed that all the above-stated steps performed in parallel in all the relevant nodes have been completed, by barrier synchronization between the at least one other node (non-self-node) and the checkpoint system. At 170, a checkpoint recovery end notification is transmitted to the calculation body of the self-node, and the notification is received by the calculation body at 120. Thereby, at 130, the calculation body of the self-node resumes execution from the start of the convergence calculation being executed at the time of acquiring the checkpoint.

In the present embodiment, since calculation is not stopped at the time of acquiring a checkpoint, the data in which the contents of the memory acquired at different timings (points of time) are mixed are used for a process of recovery from the checkpoint. The reason why use of such data is permitted is that its use is limited to iteration-method convergence calculation. In general, in an iteration method, an approximate value calculated in another method, a fixed value (for example, all zeros), a random number or the like is used as an initial value of a solution. In the calculation, approximation is performed on the basis of a given initial value so that difference from a correct solution (residual) becomes smaller every iteration, and the iteration is repeated until the residual is equal to or smaller than a value specified in advance.

In the present approach, among checkpoint data, the data in which values at different points of time are mixed is acquired. However, in the present embodiment, since the problem that a convergence destination does not depend on an initial value is assumed, convergence to the same value is guaranteed regardless of an initial value. That is, among checkpoint data, even if the data in which values at different points of time are mixed is used, the termination of calculation in the case of being recovered and the validity of a calculation result are guaranteed.

Next, the number of iterations for convergence in the case of being recovered from the data in which values at different points of time are mixed, among checkpoint data, will be described. In an iteration method, the current solution is made closer to a correct solution every iteration. Therefore, in general, by using an initial value closer to the correct solution, convergence to the correct solution becomes possible by a smaller number of iterations. Thus, an initial value closer to a correct solution can be obtained by using a value after more iterations have been performed even if acquisition points of time are mixed, like the checkpoint acquisition method of the present invention, and thereby, the number of iterations performed until convergence at the time of recovery can be reduced.

The approach of the present embodiment can be embodied as a node, a method implemented in the node, or a method or system for making computer calculations in parallel among multiple nodes. The present approach can be also embodied as a computer program product including a computer readable storage medium having computer readable non-transient program code embodied therein, causing a CPU (calculation body), a check system or an integration thereof which is included in a certain node (self-node), to execute each step of the method.

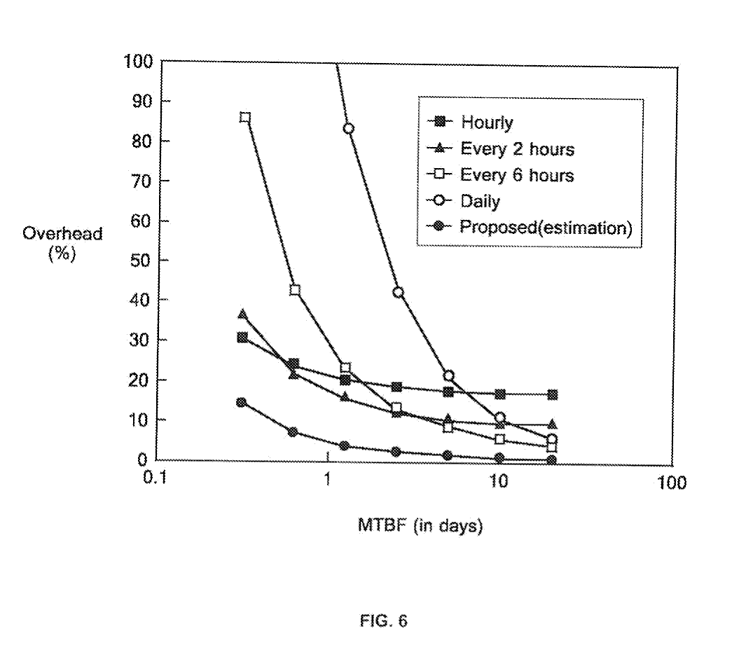

FIG. 6 is a graph of the cost for reliability expected when the approach of the present embodiment is implemented and which has been theoretically calculated. Theoretical values are shown which are calculated as calculation time loss cost on the assumption that overhead=checkpoint acquisition cost+failure, in the case of MTBF of 0.3 days and the amount of time required for checkpoint of 10 minutes.

However, the calculation is performed on the condition that the calculation time is not increased by the background checkpoint acquisition overhead. (It is assumed that resources other than a CPU performing calculations are not used at all or almost at all. In the case of using I/O resources, the effect of the invention may be reduced according to the rate of the use.)

The “proposed (estimation)” data in the graph indicates theoretical overhead values when the present invention is applied. Other data indicate overhead when the checkpoint acquisition interval is set as 1 hour, 2 hours, 6 hours and 1 day, respectively. The present embodiment was successful in reducing overhead of 11.1% in the case of the checkpoint interval of 1 day and the MTBF of 10 days to about 0.4%.

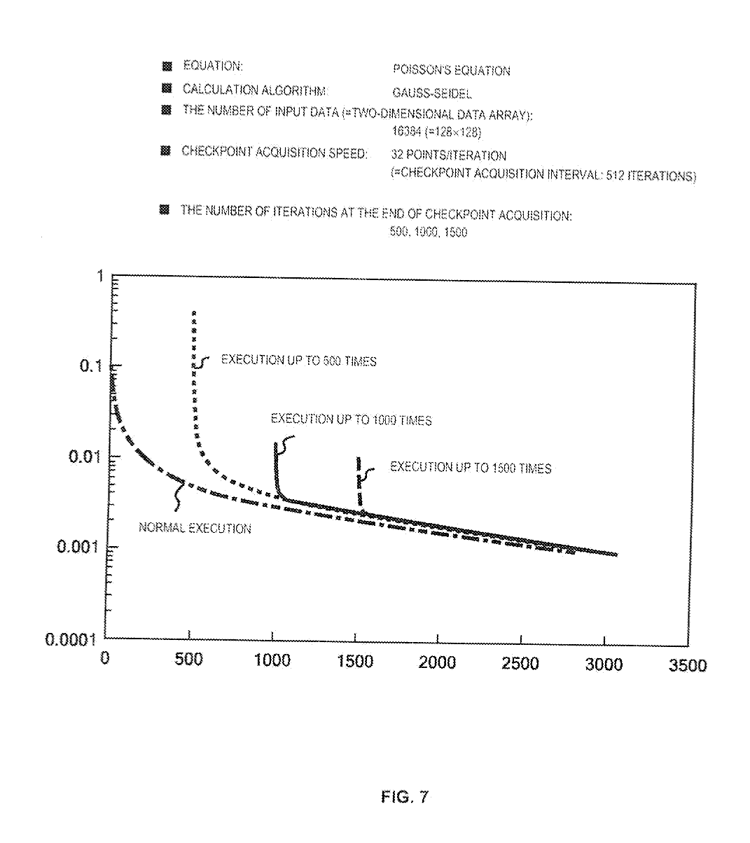

FIG. 7 is a graph showing an example of applying the approach of the present invention to a Poisson's equation.

Calculation conditions are enumerated below:

Equation: Poisson's equation
Calculation algorithm: Gauss-Seidel
The number of input data (=two-dimensional data arrays): 16384 (=128×128)
Checkpoint acquisition speed: 32 points/iteration (=checkpoint acquisition interval of 512 iterations)
The number of iterations which have been performed when checkpoint acquisition ends: 500, 1000, 1500

In the present embodiment example the same scheme as shown in the above configuration and procedures is used. However, the checkpoint system and the calculation body in the above configuration are integrated and realized as the same program. There are shown below residuals in the case of acquiring checkpoints at the 500th, 1000th and 1500th iterations after the start of calculation and recovering from the acquired checkpoints. In order to show how the number of iterations before acquisition influences the number of iterations after acquisition, the graph shows the residuals after recovery on the basis of the number of iterations before checkpoint acquisition.

Furthermore, embodiment examples to which the present invention can be applied include (1) to (4) below:

(1) Applicable to calculation based on convergence calculation by an iteration method in which a convergence value is decided irrespective of an initial solution. A BiCG method is an example;
(2) Applicable to calculation using the Poisson equation, because it is guaranteed that in the Poisson equation a convergence value is decided regardless of an initial value. The Poisson equation is used in a variety of fields such as CFD, electrostatics, mechanical engineering, theoretical physics and first principles calculation;
(3) Applicable to calculation in which a convergence value differs depending on an initial solution. However, it is also conceivable that, by applying the present invention, convergence to a value other than an original convergence value occurs or convergence does not occur after recovery from a checkpoint. In the problem of including such calculation that a convergence value differs depending on an initial solution, there is a possibility that an execution result may change due to application of the present invention. If a user accepts this condition, the present invention can be applied to the calculation in which a convergence value differs depending on an initial solution; and
(4) At the time of acquiring a checkpoint, asynchronous communication using RDMA (Remote Direct Memory Access) or the like can be used instead of the asynchronous I/O. In this case, the checkpoint system operates on a node other than the self-node, but the procedure itself is the same. By using RDMA, checkpoint acquisition can be performed without using CPU resources of a target node. Thereby, an increase in convergence calculation time (30 in FIG. 4) caused by the checkpoint acquisition can be reduced, and the advantages of the present invention can be enhanced.

What is claimed is:

1. A system comprising a certain node and at least one other node, wherein:
said certain node starts computer calculations based on a data group for calculation belonging to a certain discrete time and executes an iteration-method calculation until a result of said calculation is converged within a predetermined range;
said certain node acquires an intermediate calculation group as a checkpoint at a predetermined timing, in parallel with the execution of said iteration-method calculation, without stopping said started computer calculations;
said certain node stores said acquired intermediate calculation group as a checkpoint into an external memory;
said certain node waits until it is confirmed that all the above-stated processes are performed in parallel in said other node and have been completed before evolving said certain discrete time to a next discrete time; and
in response to said completion being confirmed, said certain node refers to a converged calculation result and starts next computer calculations based on a next data group for calculation belonging to said next discrete time.

2. The system according to claim 1, wherein each of the nodes is capable of independently making computer calculations as a node comprising a CPU, a check system and a memory, these multiple nodes being linked so as to be communicable with each other, and said system making said computer calculations in parallel between these multiple nodes while evolving said data groups for calculation belonging to some discrete time, from said certain discrete time to said next discrete time.

3. The system according to claim 1, wherein, for recovery from a checkpoint:
the certain node further refers to said acquired intermediate calculation group as a checkpoint, said intermediate calculation group being stored in the external memory; and
said certain node further starts computer calculations based on said data group and data and executes said iteration-method calculation until the result of said calculation is converged within said predetermined range.

4. A node capable of independently making computer calculations, comprising a CPU, a check system and a memory, said node being linked with at least one other node so as to be communicable with each other, said computer calculations being made in parallel between these multiple nodes while a data group for calculation belonging to some discrete time is evolved from a certain discrete time to a next discrete time, wherein said node:
starts computer calculations based on said data group for calculation belonging to said certain discrete time and executes an iteration-method calculation until a result of said calculation is converged within a predetermined range;
acquires an intermediate calculation group as a checkpoint at a predetermined timing in parallel with the execution of said iteration-method calculation without stopping said started computer calculation;
stores said acquired intermediate calculation group as a checkpoint into an external memory;
waits until it is confirmed that all the above-stated processes are performed in parallel in said other node and have been completed before evolving said certain discrete time to said next discrete time; and
in response to said completion being confirmed, refers to a converged calculation result and starts next computer calculations based on a next data group for calculation belonging to said next discrete time.

5. The node according to claim 4, for recovery from a checkpoint,
further referring to said acquired intermediate calculation group as a checkpoint, said intermediate calculation group being stored in said external memory; and
starting computer calculations based on said data group and data and executing said iteration-method calculation until the result of said calculation is converged within said predetermined range.
